(19) United States
(12) Patent Application Publication
(10) Pub. No.: US 2019/0068876 A1
(43) Pub. Date: Feb. 28, 2019

(54) Method Of Image Alignment For Stitching Using A Hybrid Strategy

(71) Applicant: Nokia Technologies Oy, Espoo (FI)

(72) Inventors: Muninder Veldandi, Sunnyvale, CA (US); Prasad Balasubramanian, Sunnyvale, CA (US)

(73) Assignee: Nokia Technologies Oy

(21) Appl. No.: 15/689,109

(22) Filed: Aug. 29, 2017

(51) Int. Cl. H04N 5/232; G06T 5/40

(52) U.S. Cl. CPC H04N 5/23238; G06T 7/30; G06T 5/40

(57) ABSTRACT

The present invention may be summarized as a hybrid approach for computing the convergence of a seam region of two overlapping images, in particular, segment regions of a seam region, by using (a) convergence estimates from an SSD-based search and (b) convergence estimates from optical flow, to arrive at a final convergence value towards image alignment for stitching.

### TECHNICAL FIELD

The present invention relates to the stitching of images taken by more than one camera into a single high-quality image.

### BACKGROUND

This section is intended to provide a background or context to the invention disclosed below. The description herein may include concepts that could be pursued, but are not necessarily ones that have been previously conceived, implemented, or described. Therefore, unless otherwise explicitly indicated herein, what is described in this section is not prior art to the description in this application, and is not admitted to be prior art by inclusion in this section.

The present invention belongs to the category of “stitching” and streaming images for panorama-, and 3D-360°/Virtual Reality/Augmented Reality-based applications, where the content is captured from multiple cameras which have overlapping content. The present invention is related to the generation of high-quality stitching from multiple images. Optical flow from the overlap region of the cameras is computed and used in such a process.

The process of stitching 2D- and 3D-360° videos at reasonably high quality can be a computationally intensive and time-consuming process. The present invention proposes an optimization to the process of stitching 2D- and 3D-360° videos from multi-camera constellations with some overlap, and could benefit live-streaming use cases and offline-content workflows requiring a fast turnaround.

Multiple cameras in a certain capture configuration are used to capture 360-degree content, which is subsequently stitched to form a stereo panorama. Regular geometric-based stitching methods, such as affine or homography, generate stitching artifacts, when the scene has depth variations in an overlap region where images being stitched together have common subject matter. In order to create stitching of better quality, depth variations in the overlapped regions should be handled carefully. The following are two state-of-the-art best practices for generating high quality stitching.

The first is a fast method using blending, such as multi-band. This method gives rise to artifacts in the seam region, especially when the seam region includes content with varying depth.

The other method is a compute-intensive method, which involves computing optical flow/disparity vectors and performing a view synthesis of the overlap region from disparity and native camera-images. This method gives results superior to those obtained with the fast method.

The fast method is only good for mono-panorama; in the case of stereo-panorama, even though stitching seams are placed at the same position, while the objects in the scenes are shifted, artifacts for the most part remain high. The compute-intensive method generates the best quality stitching, but is not suitable for many applications, such as live broadcasting of virtual reality (VR), etc.

The present invention is intended to address these issues, and to provide an alternate method of aligning and stitching images without the disadvantages noted above.

### SUMMARY

This section contains examples of possible implementations and is not meant to be limiting.

In an exemplary embodiment, the present invention is a method which comprises obtaining a first image and a second image, wherein the first image and the second image overlap with one another in a seam region, and are to be stitched together at said seam region to form a combined image.

Optical flow for overlapping portions of the first image and the second image is computed, and the overlapping portions of said first image and said second image are divided into a plurality of segments.

A representative maxflow for each of the segments of the overlapping portions of said first image (maxflow_1) and said second image (maxflow_2) is computed.

Convergence limits, convLow and convHigh, of a final convergence (finalConv) are computed from maxflow_1, and flow convergence using maxflow_1 and maxflow_2 are also computed, the convergences being flowConv1 and flowConv2, respectively. The flow consistencies for maxflow_1 and maxflow_2, and the convergence consistencies for flowConv1 and flowConv2 are checked.

The average (flowConv) of flowConv1 and flowConv2 is calculated. When flow and convergence consistencies are satisfied, whether flowConv is greater than convLow is checked. When flowConv is greater than convLow, finalConv is set to be equal to flowConv, and finalConv is used for stitching the first image to the second image at said seam region to form the combined image.

On the other hand, when flow and convergence consistencies are not satisfied, or when flowConv is not greater than convLow, computing convergence (distConv) is computed using a distance-based approach. Then, whether distConv is greater than convLow and less than convHigh is determined.

When distConv is greater than convLow and less than convHigh, finalConv is set to be equal to distConv. Otherwise, when distConv is not greater than convLow and less than convHigh, finalConv is set to be equal to convLow.

In another exemplary embodiment, the present invention is an apparatus which comprises a first camera for obtaining a first image, and a second camera for obtaining a second image. The apparatus further includes at least one processor, and at least one memory including computer program code. The at least one memory and the computer program code are configured, with the at least one processor, to cause the apparatus to perform the method described in the preceding paragraphs.

In yet another exemplary embodiment, the present invention is an apparatus having means for performing the various steps in the method described in the preceding paragraphs.

In still another exemplary embodiment, the present invention is a computer program product comprising a non-transitory computer-readable storage medium bearing computer program code embodied therein for use with an apparatus. The computer program code comprising code for performing the various steps in the method described in the preceding paragraphs.

### BRIEF DESCRIPTION OF THE DRAWINGS

In the attached Drawing Figures:

FIG. 1 is a flow chart for the method of the present invention;

FIG. 2 is a flow chart for computing the maxFlow for a given segment in a seam region; and

FIG. 3 is an exemplary system for practicing various exemplary embodiments.

### DETAILED DESCRIPTION OF THE DRAWINGS

In brief, the present invention provides an alignment method in which objects in the overlap regions of two images are aligned based on a convergence/scaling function of the images from their centers. Optimal convergence leads to better alignment of the objects at the overlap region, and the method for computing optimal convergence is disclosed. The convergence is computed by aggregating information from multiple fronts using approaches, such as pixel similarity/distance, optical flow, and a combination of both.

This description will begin with an introduction to convergence and to the terminology which will be used in the discussion to follow. Convergence is a function which scales an image coordinate by a given amount, known as the convergence value. The scaling is done for all pixel coordinates with respect to an image center, which serves as the origin of the scaling.

If c(x,y) is the convergence at point (x,y), x,y being the coordinates of a point in one of the two images being stitched, then an output image, I_out, is computed using c(x,y) and input image I_in (x,y) by using the following expressions:

xᵢ=x−cx

yᵢ=y−cy

where cx,cy are the coordinates of the center points of a fish-eye image, and (xᵢ,yᵢ) are normalized image coordinates, that is to say, xᵢ,yᵢ are the coordinates relative to the image centers, which serve the origins of the images.

Then,

dx=xᵢ*c(x,y)

dy=yᵢ*c(x,y)

where dx and dy are the changes in the coordinates of the input image points (xᵢ,yᵢ) following application of the convergence.

Finally, the coordinates of the corresponding point in the output image are obtained from:

xₒ=dx+cx

yₒ=dy+cy

Thus, an input image is transformed to an output image using a scaling factor; that is

I_out(xₒ,yₒ)=I_in(xᵢ,yᵢ)

Objects in the overlapping seam regions of the images must optimally be at a farther depth, that is, located far away from the camera, for stitching to be successful. Convergence scaling is used to align images at different depths for scaling.

Since objects at different depths in the seam region are not usually aligned in stitching, the convergence value is varied across the seam region, in the horizontal and vertical directions, to align the objects.

In the discussion to follow, the following abbreviations will be used:
SSD sum of squared differences
distConv convergence estimate derived from a distance-based method
flowConv convergence estimate derived from an optical flow-based method

Having provided this background material, the present invention may be summarized as a hybrid approach for computing the convergence of a seam region, in particular, segment regions of a seam region, by using (a) convergence estimates from an SSD-based search and (b) convergence estimates from optical flow, to arrive at a final convergence value towards image alignment for stitching.

The convergence estimate from optical flow is further verified using a flow-confidence criterion. The flow confidence criterion basically checks the consistency of the optical flow between the seam region segments from the left and right cameras. That is, in a segment of the seam region, the similarity of the foreground region flow is computed from left-image and right-image regions. This is referred to as Consistency-1.

The convergence estimates from both optical flows, right-image and left-image, are verified to lie between pre-defined limits. These are convLow and convHigh, which are minimum and maximum values of the convergence. This is referred to as Consistency-2.

If Consistency-1 and Consistency-2 are satisfied for a given segment of a seam region, then the final convergence for that segment is computed as the average of the flow-based convergences. Otherwise, the convergence is estimated by using an SSD distance-based method.

The convergence estimate from the SSD distance-based method is further verified to lie within a range of convergence values between convLow and convHigh, whereas the convergence range is computed using the maxflow for that segment in the seam region. These limits, convLow and convHigh, are empirically tuned and calculated. In the implementation corresponding to the present invention, they are computed using a linear interpolation function from the given maxflow value as follows:

```
Computing convLow:
minFlowLimit = 3.0;
maxFlowLimit = 40.0;
minConvLimit = 1.01;
maxConvLimit = 1.06;
if (maxFlow > minFlowLimit),
    convLow = minConvLimit + (f − minFlowLimit) * (maxConvLimit −
    minConvLimit) / (maxFlowLimit − minFlowLimit);
else
    convLow = 1.00;
Computing convHigh:
minFlowLimit = 3.0;
maxFlowLimit = 20.0;
minConvLimit = 1.035;
maxConvLimit = 1.09;
if( maxFlow > minFlowLimit)
    convHigh = minConvLimit + (f − minFlowLimit) *
    (maxConvLimit − minConvLimit)/(maxFlowLimit − minFlowLimit);
else
    convHigh = 1.03;
```

If this last estimate fails, then the final convergence (finalConv) is the same as the minimum convergence boundary value (convLow) computed from the max flow for that segment.

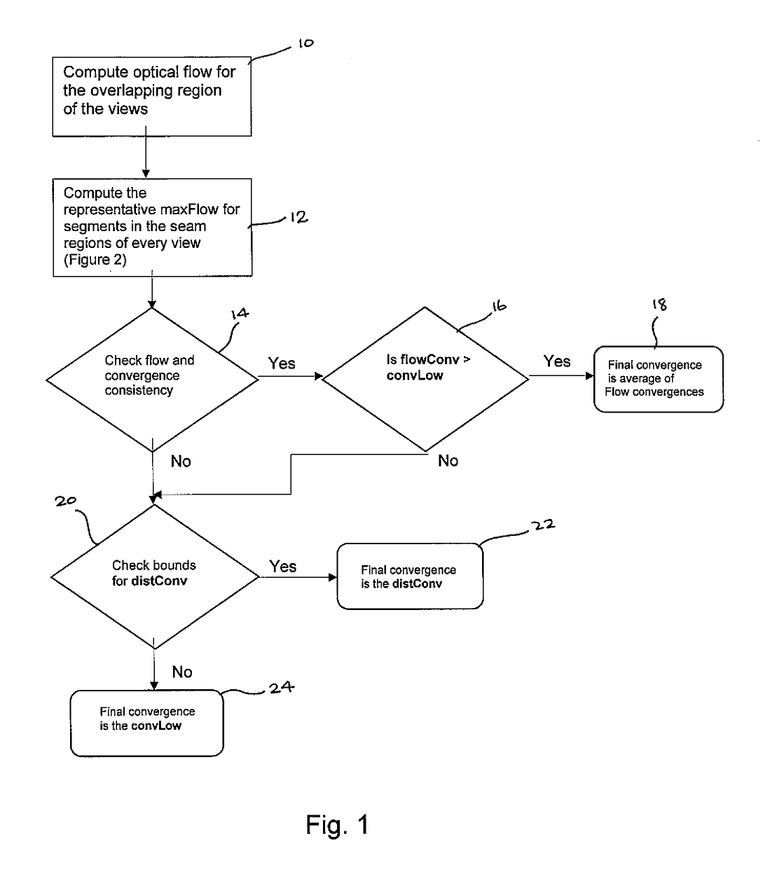

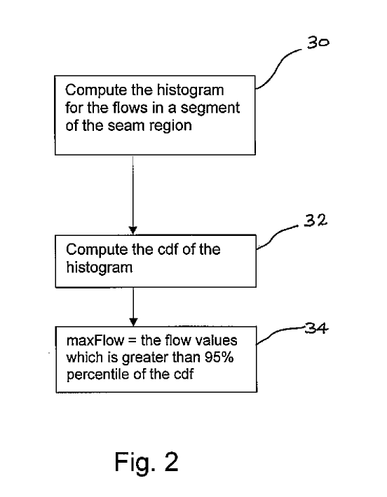

The preceding paragraphs will now be discussed in greater detail with reference being made to the figures, of which FIG. 1 is a flow chart for the method of the present invention, and FIG. 2 is a flow chart for computing the maxFlow for a given segment in a seam region. These figures will be referred to frequently in the discussion to follow.

Referring first to FIG. 1, in block 10, the optical flow for the overlapping seam regions of the views is computed. Since two or three views are being overlapped, the optical flow is computed for each view as a reference. Optical flow measures the amount of movement of corresponding pixels between the images, such as right image and left image, to obtain what is referred to as a flow map.

For every image, for the seam region, and for a segment, that is, a vertical division (strip) of the seam region, a representative maxflow is computed, as indicated in block 12, where reference is made to FIG. 2. There may be twenty segments or vertical strips for each image in the overlapping seam regions. The representative maxflow is computed, referring to block 30 in FIG. 2, by using the histogram of flows in the segment, and the flow which hits the 95% percentile of the “cdf” function is the “maxflow” for a view, as indicated in blocks 32 and 34 in FIG. 2. We will consider maxflow_i to be the maxflow for the i^{th} view.

Using maxflow_1, the convergence limits are computed. These are convLow and convHigh, which denote the lower and upper bounds of the final convergence. Let finalConv=flowConv be an initialization value for the final convergence.

The first part of the determination of flow convergence consistency is carried out as follows: the convergence estimate from all the optical flow representatives, maxflow_1, maxflow_2, and so forth, is computed as follows:

flowConv1=(x₁+maxflow_1−cx₁)/(x₁−cx₁)

flowConv2=(x₂+maxflow_2−cx₂)/(x₂−cx₂)

where

flowConv1 is the flow convergence estimate for the segment of image1,

flowConv2 is the flow convergence estimate for the segment of image2,

x₁ and x₂ are the x-coordinate averages in the segment, and

cx₁ and cx₂ are the x-coordinate image centers of two overlapping cameras.

If (|(flowConv1−flowConv2)|<flowconvergence_diff_threshold), then consistency_1_enable=true (or yes). The flowconvergence_diff_threshold is computed empirically and is equal to 0.035 in the implementation corresponding to the present invention.

The second part of the determination of flow convergence is carried out as follows: the consistency between the optical flows of the overlapping region is computed as follows:

If (|(maxflow_1−maxflow_2)|<flowConsistency_threshold), then consistency_2_enable=true (or yes), and the convergence estimate from flow is reliable. These two consistency checks are represented in block 14 in FIG. 1.

If the two parts of the determination of flow convergence are true (or yes), then the final convergence (finalConv) is the average of the flowConv1 and flowConv2 (flowConv), as indicated in block 18 of FIG. 1, provided that flowConv is greater than convLow, as indicated in block 16.

However, if at least one part of the determination of flow convergence consistency is not true, then the convergence estimate using a distance-based search (distConv) is computed and evaluated for consistency using the flow information, as indicated in block 20 of FIG. 1.

The distConv is computed as follows: let images I₁ and I₂ be images from cameras C₁ and C2. In general, images I₁ and I₂ are images captured by two cameras having a common overlap region.

The seam regions from images I₁ and I₂ are considered, and a set of convergence values (N) are applied to these seam regions or strips. The resulting strips are denoted by I_{1y} and I_{2y}. This step generates N strips corresponding to each strip I_{1y} and I_{2y}.

The following equation is used to compute the convergence which gives minimum SSD between the strips.

SSD-based search: argmin(Σ((I_{1y}(x)−I_{2y}(x)))²)

The convergence obtained by distance-based convergence is then validated against the convLow and convHigh bounds, at block 20, as follows:

If ( ( distConv > convLow ) and ( distConv < convHigh ) ),
then finalConv = distConv (block 22),
otherwise finalConv = convLow (block 24).

The present method has the advantage of being independent of calibration information, and inherits the best properties of both distance-based convergence and flow-based convergence methods and hence produces better results than either of these methods. All of these benefits are applicable to the mono scopic panorama case and generate improved results with respect to not using convergence at all.

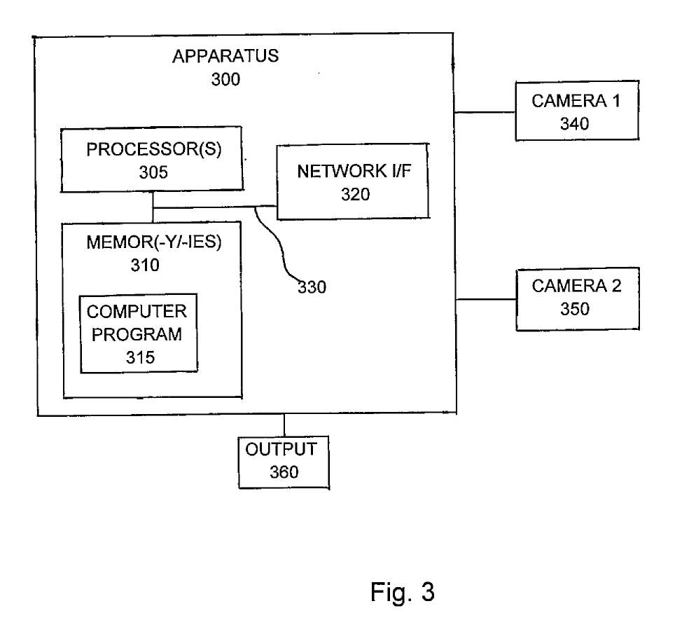

FIG. 3 shows an exemplary system for practicing various embodiments of the present invention. The system includes an apparatus 300 having one or more processors 305, one or more memories 310, and one or more network interfaces 320, interconnected using one or more buses 330. The one or more memories 310 include a computer program 315 defined to cause the apparatus to perform one or more of the operations described herein.

Camera 1 340 and Camera 2 350 provide input to the apparatus 300. A stitched image obtained by combining the images obtained by Camera 1 340 and Camera 2 350 in accordance with the process described above is sent to the output 360.

As will be appreciated by one skilled in the art, aspects of the present invention may be embodied as an apparatus, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit”, “module”, or “system.” Furthermore, aspects of the present invention may take the form of a computer program product embodied in one or more computer-readable medium(s) having computer-readable program code embodied thereon.

Any combination of one or more computer-readable medium/media may be utilized. The computer-readable medium may be a computer-readable signal medium or a computer-readable storage medium. A computer-readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, and so forth, or any suitable combination of the foregoing.

Computer program code for carrying out operations for aspects of the present invention may be written in any combination of one or more programming languages, including an object-oriented programming language, such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer, for example, through the Internet using an Internet Service Provider.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable-medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any and all means or step plus function elements in the claims below are intended to include any structure, material, or act for performing the function in combination with other claimed elements as specifically claimed. The description of various embodiments has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various modifications and adaptations may become apparent to those skilled in the relevant arts in view of the foregoing description, when read in conjunction with the accompanying drawings. However, any and all modifications of the teachings of this disclosure will still fall within the scope of the non-limiting embodiments of this invention.

Although described in the context of particular embodiments, it will be apparent to those skilled in the art that a number of modifications and various changes to these teachings may occur. Thus, while the invention has been particularly shown and described with respect to one or more embodiments thereof, it will be understood by those skilled in the art that certain modifications or changes may be made therein without departing from the scope of the invention as set forth above, or from the scope of the claims to follow.

What is claimed is:

1. A method comprising:
obtaining a first image and a second image, said first image and said second image overlapping with one another in a seam region, said first and second images to be stitched together at said seam region to form a combined image;
computing optical flow for overlapping portions of said first image and said second image;
dividing the overlapping portions of said first image and said second image into a plurality of segments;
computing a representative maxflow for each of said segments of said overlapping portions of said first image (maxflow_1) and said second image (maxflow_2);
computing convergence limits, convLow and convHigh, of a final convergence (finalConv) from maxflow_1;
computing flow convergence using maxflow_1 and maxflow_2, the convergences being flowConv1 and flowConv2, respectively;
checking the flow consistencies for maxflow_1 and maxflow_2, and the convergence consistencies for flowConv1 and flowConv2;
calculating the average (flowConv) of flowConv1 and flowConv2;
when flow and convergence consistencies are satisfied, checking whether flowConv is greater than convLow;
when flowConv is greater than convLow, setting finalConv to be equal to flowConv; and
using finalConv for stitching the first image to the second image at said seam region to form said combined image.

2. The method as claimed in claim 1, further comprising:
when flow and convergence consistencies are not satisfied, or when flowConv is not greater than convLow, computing convergence (distConv) using a distance-based approach;
determining whether distConv is greater than convLow and less than convHigh;
when distConv is greater than convLow and less than convHigh, setting finalConv to be equal to distConv; and
when distConv is not greater than convLow and less than convHigh, setting finalConv to be equal to convLow.

3. The method as claimed in claim 1, wherein the convergence consistency is satisfied when the absolute value of the difference between flowConv1 and flowConv2 is less than a flowconvergence_diff_threshold.

4. The method as claimed in claim 1, wherein the flow consistency is satisfied when the absolute value of the difference between maxflow_1 and maxflow_2 is less than a flowConsistency_threshold.

5. The method as claimed in claim 2, wherein distConv is computed by minimizing the sum of the squared differences between the overlapping portions of the first image and the second image.

6. An apparatus comprising:
a first camera for obtaining a first image;
a second camera for obtaining a second image;
at least one processor; and
at least one memory including computer program code, the at least one memory and the computer program code configured, with the at least one processor, to cause the apparatus to perform:
obtain a first image and a second image, said first image and said second image overlapping with one another in a seam region, said first and second images to be stitched together at said seam region to form a combined image;
compute optical flow for overlapping portions of said first image and said second image;
divide the overlapping portions of said first image and said second image into a plurality of segments;
compute a representative maxflow for each of said segments of said overlapping portions of said first image (maxflow_1) and said second image (maxflow_2);
compute convergence limits, convLow and convHigh, of a final convergence (finalConv) from maxflow_1;
compute flow convergence using maxflow_1 and maxflow_2, the convergences being flowConv1 and flowConv2, respectively;
check the flow consistencies for maxflow_1 and maxflow_2, and the convergence consistencies for flowConv1 and flowConv2;
calculate the average (flowConv) of flowConv1 and flowConv2;
when flow and convergence consistencies are satisfied, check whether flowConv is greater than convLow;
when flowConv is greater than convLow, set finalConv to be equal to flowConv; and
using finalConv for stitching the first image to the second image at said seam region to form said combined image.

7. The apparatus as claimed in claim 6, wherein the at least one memory and the computer program code are further configured, with the at least one processor, to:
when flow and convergence consistencies are not satisfied, or when flowConv is not greater than convLow, compute convergence (distConv) using a distance based approach;
determine whether distConv is greater than convLow and less than convHigh;
when distConv is greater than convLow and less than convHigh, set finalConv to be equal to distConv; and
when distConv is not greater than convLow and less than convHigh, set finalConv to be equal to convLow.

8. The apparatus as claimed in claim 6, wherein the convergence consistency is satisfied when the absolute value of the difference between flowConv1 and flowConv2 is less than a flowconvergence_diff_threshold.

9. The apparatus as claimed in claim 6, wherein the flow consistency is satisfied when the absolute value of the difference between maxflow_1 and maxflow_2 is less than a flowConsistency_threshold.

10. The apparatus as claimed in claim 7, wherein distConv is computed by minimizing the sum of the squared differences between the overlapping portions of the first image and the second image.

11. An apparatus comprising:
means for obtaining a first image and a second image, said first image and said second image overlapping with one another in a seam region, said first and second images to be stitched together at said seam region to form a combined image;
means for computing optical flow for overlapping portions of said first image and said second image;
means for dividing the overlapping portions of said first image and said second image into a plurality of segments;
means for computing a representative maxflow for each of said segments of said overlapping portions of said first image (maxflow_1) and said second image (maxflow_2);
means for computing convergence limits, convLow and convHigh, of a final convergence (finalConv) from maxflow_1;
means for computing flow convergence using maxflow_1 and maxflow_2, the convergences being flowConv1 and flowConv2, respectively;
means for checking the flow consistencies for maxflow_1 and maxflow_2, and the convergence consistencies for flowConv1 and flowConv2;
means for calculating the average (flowConv) of flowConv1 and flowConv2;
means for checking whether flowConv is greater than convLow, when flow and convergence consistencies are satisfied;
means for setting finalConv to be equal to flowConv, when flowConv is greater than convLow; and
means for using finalConv for stitching the first image to the second image at said seam region to form said combined image.

12. The apparatus as claimed in claim 11, further comprising:
means for computing convergence (distConv) using a distance-based approach, when flow and convergence consistencies are not satisfied, or when flowConv is not greater than convLow;
means for determining whether distConv is greater than convLow and less than convHigh;
means for setting finalConv to be equal to distConv, when distConv is greater than convLow and less than convHigh; and
means for setting finalConv to be equal to convLow, when distConv is not greater than convLow and less than convHigh.

13. The apparatus as claimed in claim 11, wherein the convergence consistency is satisfied when the absolute value of the difference between flowConv1 and flowConv2 is less than a flowconvergence_diff_threshold.

14. The apparatus as claimed in claim 11, wherein the flow consistency is satisfied when the absolute value of the difference between maxflow_1 and maxflow_2 is less than a flowConsistency_threshold.

15. The apparatus as claimed in claim 12, wherein distConv is computed by minimizing the sum of the squared differences between the overlapping portions of the first image and the second image.

16. A computer program product comprising a non-transitory computer-readable storage medium bearing computer program code embodied therein for use with an apparatus, the computer program code comprising code for performing at least the following:
obtaining a first image and a second image, said first image and said second image overlapping with one another in a seam region, said first and second images to be stitched together at said seam region to form a combined image;
computing optical flow for overlapping portions of said first image and said second image;
dividing the overlapping portions of said first image and said second image into a plurality of segments;
computing a representative maxflow for each of said segments of said overlapping portions of said first image (maxflow_1) and said second image (maxflow_2);
computing convergence limits, convLow and convHigh, of a final convergence (finalConv) from maxflow_1;
computing flow convergence using maxflow_1 and maxflow_2, the convergences being flowConv1 and flowConv2, respectively;
checking the flow consistencies for maxflow_1 and maxflow_2, and the convergence consistencies for flowConv1 and flowConv2;
calculating the average (flowConv) of flowConv1 and flowConv2;
when flow and convergence consistencies are satisfied, checking whether flowConv is greater than convLow;
when flowConv is greater than convLow, setting finalConv to be equal to flowConv; and
using finalConv for stitching the first image to the second image at said seam region to form said combined image.

17. The computer program product as claimed in claim 16, further comprising code for performing:
when flow and convergence consistencies are not satisfied, or when flowConv is not greater than convLow, computing convergence (distConv) using a distance-based approach;
determining whether distConv is greater than convLow and less than convHigh;
when distConv is greater than convLow and less than convHigh, setting finalConv to be equal to distConv; and
when distConv is not greater than convLow and less than convHigh, setting finalConv to be equal to convLow.

18. The computer program product as claimed in claim 16, wherein the convergence consistency is satisfied when the absolute value of the difference between flowConv1 and flowConv2 is less than a flowconvergence_diff_threshold.

19. The computer program product as claimed in claim 16, wherein the flow consistency is satisfied when the absolute value of the difference between maxflow_1 and maxflow_2 is less than a flowConsistency_threshold.

20. The computer program product as claimed in claim 17, wherein distConv is computed by minimizing the sum of the squared differences between the overlapping portions of the first image and the second image.
